(19) United States
(12) Patent Application Publication
(10) Pub. No.: US 2002/0184064 A1
(43) Pub. Date: Dec. 5, 2002

(54) Business providing a service by cross-referencing a postal address to a location provided by a position locator

(75) Inventors: Henri Daniel Schnurmann, Monsey, NY (US); Louis P. Herzberg, Monsey, NY (US)

Correspondence Address: Louis J. Percello, Intellectual Property Law Dept., IBM Corporation, P.O. Box 218, Yorktown Heights, NY, 10598, US

(73) Assignee: International Business Machines Corporation, Armonk, NY (US)

(21) Appl. No.: 09/873,173

(22) Filed: Jun. 1, 2001

(51) Int. Cl. G06F 17/60

(52) U.S. Cl. 705/7

(57) ABSTRACT

A method and a system for delivering a service at an address determined by cross-referencing a postal address to a location provided a position locator, e.g., GPS, is described. The service is delivered with minimum delay by allowing the service supplier prompted by a client to immediately prepare for the delivery of the service without having to return to base (i.e., point of departure) or to rely on a monitor to make the necessary arrangements. To this end, a database is created to include information pertinent to the clients of this service, and having whatever is necessary to service the clients available at all times. The service includes among others: specialized postal services, delivery of medication, response to emergencies, answering distress calls, and the like. The client includes individuals, and businesses servicing other business providers.

### FIELD OF THE INVENTION

This invention relates generally to a geographic location referencing system, and more particularly, to a business method for delivering a service to a client at a location obtained by cross-referencing a postal address to a location provided by a position locator.

### BACKGROUND OF THE INVENTION

Locating an exact geographical position has been significantly impacted by the availability of GPS to provide worldwide position locations. GPS consists of a network of satellites that interact with a controller coupled to a GPS receiver. The precise terrestrial (also referred to hereinafter as geographic) location provided by GPS is typically outputted in terms of a latitude and longitude.

A problem exists when the only available position information is the one provided by a position locator, such as GPS, since a service supplier may find it difficult to correlate the GPS position to its corresponding postal address. Attempts have been made to solve this problem as, for instance, in U.S. Pat. No. 5,839,088 to Hancock et al., which describes a navigational system that includes a GPS receiver that provides the geographical coordinates, and an input device that generates a set of local addresses that are unique to the geographical area of interest. This system will be referred to hereinafter as GPS locator.

U.S. Pat. No. 6,133,853 to Obradovich, describes a personal communication device to pinpoint the geographical location of a client. A computer tracks the location of the client at all times, displaying a map with the information regarding that location;

U.S. Pat. No. 5,596,500 to Sprague et al. describes a map reading system that includes a GPS receiver, a map coordinates interpreter and a data base of published map sheets representing coordinate points on the map sheets. The system as described, relates points on the geographical map to the GPS data in order to pinpoint the selected location.

U.K. Patent No. 2,322,445 to Blain describes a system for entering terrestrial coordinates and cross-correlating these coordinates to a given postal address. More particularly, and with reference to FIG. 1, there is shown a block diagram of a conventional terrestrial system described in the aforementioned U.K. patent. The terrestrial coordinates are assumed to be provided by a GPS receiver. Navigational system is connected to GPS receiver 60 which intermittently receives signals from satellites 120. These signal make it possible to determine accurately its position on the earth's surface in terms of terrestrial coordinates which is determined by GPS receiver 60 utilizing GPS interface 70. Input address data is entered via key input device 110 and the address information is received by input interface 20. The navigational data is then transferred to address converter 40 by way of processor 30. The address converter 40 accesses database 50, associating postal address identifiers to the terrestrial coordinates. The result of accessing database 50 by way of address converter 40 makes it possible to retrieve the latitude and longitude data corresponding to the postal address specified by the client. The processor 30 outputs data to output interface 80, transferring the required data to the appropriate displays. e.g., display device 90 or speaker 100. Key input device 110 allows entering a command to provide relative direction information to allow a vehicle to travel to a predetermined destination without knowing the exact routing.

Providing a service at a given address often presents serious difficulties. For instance, an emergency vehicle at night in a rural or suburb may find it difficult to locate an exact postal address even when the street location is known. Numbers that identify a particular house may not be clearly visible at night or may be missing altogether. As a result, medical, police, fire, and like personnel in emergency vehicles waste precious time attempting to find the exact location. This problem is compounded when the emergency crew arriving at the place where the call originated from finds itself lacking the necessary equipment to handle the emergency.

Delivering a service generally consists of two steps: 1) finding the location of the receiver of the service, and 2) ensuring that the supplier of the service has on hand what is needed to deliver the service in an efficient, accurate and timely manner. Ideally, the elements required to provide the service should be placed on board of the vehicle prior to the vehicle leaving the point of origin. However, unless this information is known beforehand, it is difficult to make up for this omission later without first returning to the point of departure to retrieve the necessary equipment Clearly, it would be highly advantageous to anticipate and prepare for any unforeseen circumstances by having on board whatever may be required for any situation. From a practical point of view, this is not feasible.

It would, therefore, be advantageous to have a business employing methods and apparatus for providing a service [or a business] by cross-referencing a location determined by a position locator (also referred hereinafter as a geographical location) to a postal address. Significant amounts of time could be saved by this cross-correlation. By way of example, to a business employing an untrained service supplier (e.g, a driver), cross-referencing greatly facilitates the delivery of the service to be supplied, particularly when the driver is unfamiliar with the route on hand or the best way of arriving at the predetermined address. However, even under these circumstances, it may be pointless to introduce efficiencies in locating the client unless the vehicle is equipped with whatever is necessary to deliver the service. (Note: As used herein, the term client includes a service requester, a service recipient, a member, subscriber, any service user or user surrogate of the provided service and the like. Further, the words business, service provider and service also include an entity, entity surrogate or any part thereof which provides, supplies, or delivers the advantages of the present invention).

It would also be advantageous to provide a business that allows the service supplier learn instantly about the needs of the client, and prepare for any eventuality at the earliest possible moment. This added knowledge often makes the difference between an efficient and timely delivery of the service, particularly in instances which can spell the difference between life and death.

### OBJECTS OF THE INVENTION

Accordingly, it is an object of the invention to provide a business method which employs a cross-reference of a postal address to a geographic location to provide a service at the cross-referenced location.

It is another object to create a method of doing business employing at least one data base to obtain service related information for providing at least one service to a plurality of predetermined addressees within the confines of a local geographic area.

It is yet another object to provide a business method which allows a client to initiate an emergency or otherwise urgent call to prompt the service of an emergency vehicle, wherein the exact location of the caller is determined by the previously referred cross-correlated address.

It is still another object to create a plurality of data bases, wherein each data base provides a different category of services, and wherein the addresses posted correspond to the cross-correlated addresses between the postal address and the location specified by a position locator system, and further providing a business method employing these databases.

It is a further object to have a system to identify the type of service requested by a code or by the frequency at which the call is initiated.

### SUMMARY OF THE INVENTION

In a first aspect of the invention, there is provided a business method for cross-referencing a postal address to terrestrial coordinates to provide a service at that cross-referenced address. The service delivered is provided with minimum delay by having the client initiate a call and by having the service supplier responding to the call to immediately prepare for the delivery of the service without having to return to base (i.e., point of departure) or to rely on a monitor to make the necessary arrangements. To this end, a database is created to include information pertinent to the subscribers to this service.

In another aspect of the invention, there is provided a business method providing at least one service that includes the steps of: a) cross-referencing a postal address of each client from a plurality of clients to a geographical location for each client; b) obtaining information relative to an individualized service or services to be provided to at least one of the clients; and c) providing the individualized service or services to the client based on the cross-referencing and the information.

In still another aspect of the invention, there is provided a business method for responding to a distress or other service call initiated by an individual, client and/or company at an unknown postal location. The method including the steps of: a) responsive to the distress or other service call, having a monitoring station correlate from a first data base a GPS address corresponding to the unknown postal address; b) determining from the correlated address selected information stored in a second data base pertinent to the individual in distress; c) transmitting to an emergency or service providing postal address; and d) having the emergency or other service providing vehicle deliver the service based on the correlated address and the selected information.

In still another aspect of the invention, there is provided a business method comprising delivering the service to a handicapped person at a postal address, the method including the steps of: a) creating a first database for cross-referencing the postal address to terrestrial coordinates for each addressee of a plurality of addressees; b) creating a second database for storing details pertaining the service applicable to the handicapped person to be delivered at the postal address; and c) providing the service to the handicapped person based on said cross-referenced location and on said selected information retrieved from said second database.

Thus, the invention provides a method of supplying a service, including the steps of: cross-referencing a postal address of each client from a plurality of clients to a geographical location for each client; obtaining information relative to an individualized service to be provided to at least one of the plurality of clients; and providing the individualized service to the at least one of the clients based on the cross-referencing and the information.

In particular embodiments of the method, the step of cross-referencing includes: using a first database having the postal address and the geographic location for each of the clients, and using a second data base having the information relative to the individualized service to be delivered to each of the plurality of clients; and/or the second database includes information selected from the group that includes: type of addressee, service requirements, special attention, type of occupant, mode of payment, previous postal addresses, previous terrestrial coordinates locations, forwarding postal address, forwarding terrestrial location, approved surrogates, company policies, reporting requirements and any combination of these; and/or the postal address and the terrestrial coordinates for each of the clients and the information relative to the individualized service to be delivered to each of the plurality of clients is stored in a common data base; and/or a step of ascertaining the status of the delivery of the service; and/or a step of notifying the at least one client when the individualized service is completed; and/or further includes notifying the at least one client of a planned delivery of the service.

The status of the delivery of the service is entered by the supplier of service after the service is supplied.

The invention further provides a method for responding to a distress call initiated by an individual at an unrecognized postal location, the method including the steps of: responsive to the distress call, having a monitoring station correlate from a first data base a GPS address corresponding to the unrecognized postal address; determining from the correlated address selected information stored in a second data base pertinent to the individual in distress; transmitting to an emergency vehicle the selected information and the correlated GPS address corresponding to the postal address; and having the emergency vehicle deliver the service based on the correlated address and the selected information.

In particular embodiments of this method, the information includes determining a prior medical history of the person in distress from the second data base, and responsive to the medical history providing an optimum response applicable to the person in distress.

The invention further provides a method including the step of delivering the service to a handicapped person at a postal address, the method including the steps of: creating a first database for cross-referencing the postal address to terrestrial coordinates for each addressee of a plurality of addressees; creating a second database for storing details pertaining the service applicable to the handicapped person to be delivered at the postal address; and providing the service to the handicapped person based on the cross-referenced location and on the selected information retrieved from the second database.

In particular embodiments of this method, the service includes reading at least mail addressed to the occupant who is blind; and/or the service includes paying a bill addressed to the occupant; and/or the service is selected from the group that includes: verifying whether the postal service is delivered at the correct location; determining a preferred delivery mode required by the handicapped person; notifying a sender of completion of the delivery; providing a specialized service according to the type of handicap of the handicapped person living at the postal address; forming a postal handicapped client registry; delivering the postal service at a location directed to an immobile person; delivering of medication to the bed of a sick person and any combination thereof.

The invention further provides a business system for supplying a service to an addressee at a postal address including: a first database for cross-referencing the postal address to terrestrial coordinates for each addressee of a plurality of addressees; a second database for storing selected information relative to the plurality of addressees; and means for providing the service to at least one of the addressees based on the cross-referenced location and on the selected information retrieved from the second database.

In particular embodiments of this system, the second database includes information selected from the group that includes: special needs of the addressee, postal service requirements, mode of payment, previous postal addresses, previous terrestrial position locations, forwarding postal address, forwarding terrestrial position location and any combination of these; and/or further includes means for ascertaining the status of the delivery of the service; and/or means for notifying the at least one addressee and/or a surrogate of the addressee of the completion of a particular delivery of the service; and/or means for notifying the at least one addressee and/or a surrogate of the addressee of a planned delivery of the service.

The invention further provides a business system for responding to a service request call initiated by a service requester at an unrecognized postal location, the system including: a monitoring station for responding to the service call and for correlating from a first data base a GPS address corresponding to the unrecognized postal address; means for cross-referencing with the correlated address, special information stored in a second data base pertinent to the service requester; means for transmitting to a service supply vehicle the special information and the correlated GPS address corresponding to the postal address; and delivery means for the service supply vehicle to deliver the requested service, based on the correlated address and the selected information.

In particular embodiments of this system, the service requester is a person in distress and the special information includes a prior medical history of the person in distress taken from the second data base, and, wherein the delivery means uses the medical history in providing an optimum response applicable to the person in distress; and/or the service requester is a company and the service request is for a number of copies of a publication included in the delivery means.

The invention further provides a business system and/or system for delivering at least one postal service to at least one service requester from a plurality of service requesters, each service requester for being at a known postal address. The system including: a cross referencing module for cross-referencing the known postal address to terrestrial coordinates for the at least one service requester; a second database for storing details pertaining the at least one postal service applicable to each of the plurality of service requesters to be delivered at the known postal address; and a service provider module for providing the at least one postal service to the at least one service requester, based on a cross-referenced location and on selected information retrieved from the second database.

In particular embodiments of this business or system, the at least one service requester is a handicapped person; and/or the handicapped person is blind or immobilized; and/or the postal service is selected from the group of services that includes: verification that the postal service is delivered at the correct location; a preferred delivery mode required by a handicapped person; notification to a sender of completion of the delivery; delivery of a specialized postal services according to a type of handicap of a handicapped person living at the postal address; formation of a postal client registry; delivery of the postal service at a location directed to a client companies service needs; delivery of medication to the bed of a sick person, and any combination of these.

The invention further provides an article of manufacture including a computer usable medium having computer readable code means embodied therein for causing delivery of a service, the computer readable program code means in the article of manufacture further including computer readable program code means for causing a computer to effect the steps of any of the methods of the present invention.

The invention further provides a computer program product including a computer usable medium having computer readable program code means embodied therein for causing a delivery of a service, the computer readable program code means in the computer program product including computer readable program code means for causing a computer to effect any of the businesses, systems and/or apparatus of the present invention.

### BRIEF DESCRIPTION OF THE DRAWINGS

These and other objects, aspects and advantages of the present invention will become apparent upon a consideration of the following detailed description of the invention when read in conjunction with the accompanying drawings.

FIG. 1 is a block diagram illustrating a prior art geographical position locator system providing a GPS position that is cross-correlated to a postal address.

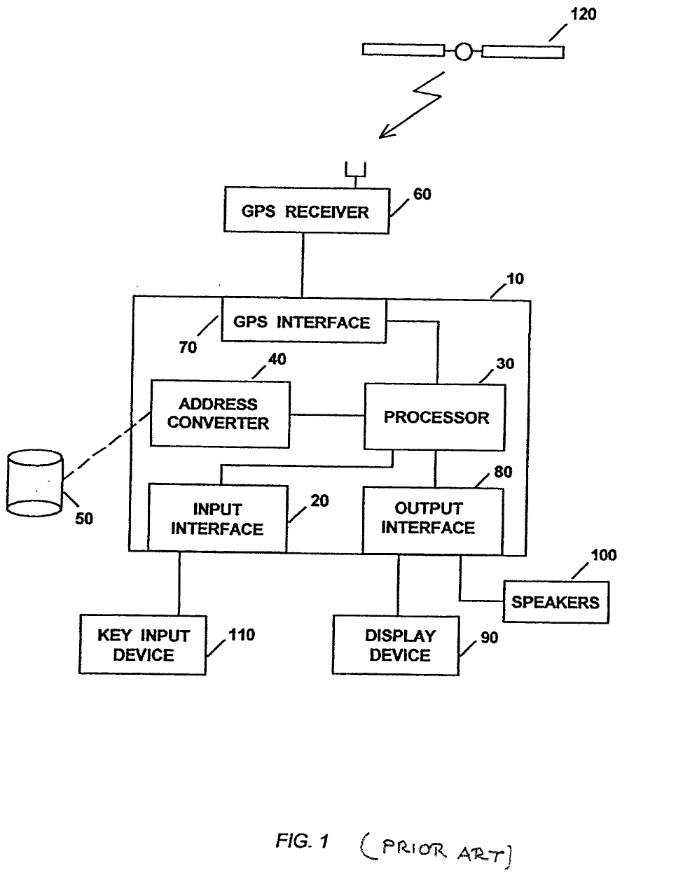

FIG. 2 shows an example or a first embodiment of the present invention wherein a business accesses at least one data base to provide at least one service at an address determined by cross-correlating a terrestrial address to a postal address and the postal address to the terrestrial address.

FIG. 3 is an example of a flow chart illustrating the processing steps performed when exercising an advantageous embodiment of the invention.

### DETAILED DESCRIPTION OF THE INVENTION

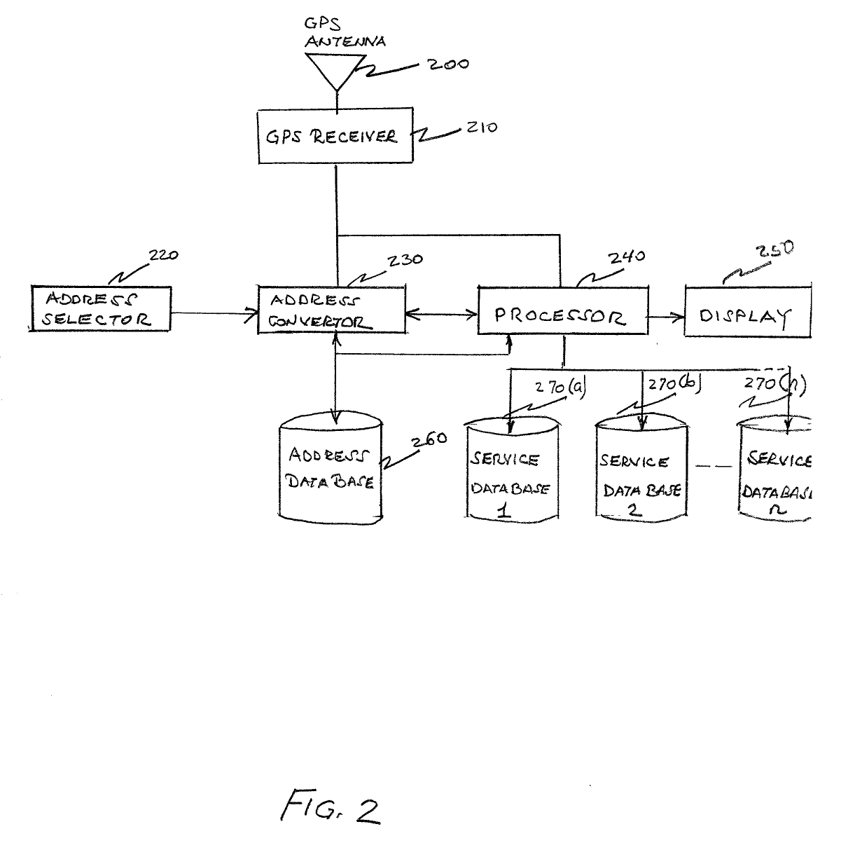

FIG. 2 illustrates an example of a block diagram of the first embodiment of the invention. Therein is shown a position locator system receiver, preferably a GPS receiver (210). It is to be understood that the invention is not limited to a GPS oriented system, but that any other terrestrial or position locator system, such as LORAN and the like, are just as adequate. Signals received by the position locator system antenna (200) are inputted into a processor (240) coupled to a display device (250) for displaying the information, in the form of a longitude, latitude and height.

An address selector (220) allows identifying the postal address of interest. This address is entered manually or automatically by the client, or a client surrogate. The address may take various forms, such as a complete street and number, city, state, and the like, a client reference or pin number supplied by the service, or the name of the resident living at that address. In the latter case, the client's name will be converted to an address by address converter (230) that interacts with the address selector or identifier (220). It will be apparent to those skilled in the art that a data base of potential clients (260), such as members or subscribers to a given service residing within the local area covered by the service supplier may be preferably stored in a data base that interacts with the address identifier. This data base may be suitably stored in any medium and may be remotely accessed anytime by authorized individuals. In some embodiments, the determination of an authorized client is provided by a pin number associated with that client subscribing to the service.

Processor (240) converts the signals received by the position locator receiver (210) into a specific location defined by the longitude and latitude. This position is generally accurate to three meters or less, an accuracy that is improving steadily as the technology progresses. Processor (240) additionally provides a cross-reference between the postal address and the position locator address, allowing the service supplier to be guided by the position locator to the postal address of interest.

Further display (250) is coupled to the processor to provide a visual input to the supplier. The display (250) can be programmed in many ways. For instance, a street or district map may show the supplier the route he has followed and the distance and route still to be covered till its destination. The display (250) may further provide visual information regarding the nature of the service to be provided at that address, with all the necessary details to ensure that the elements required for delivery are presently available. In the event that they are not, provisions may be made in anticipation to complement whatever is still required but not available at that moment to the service supplier or to the specialized personnel riding on the vehicle.

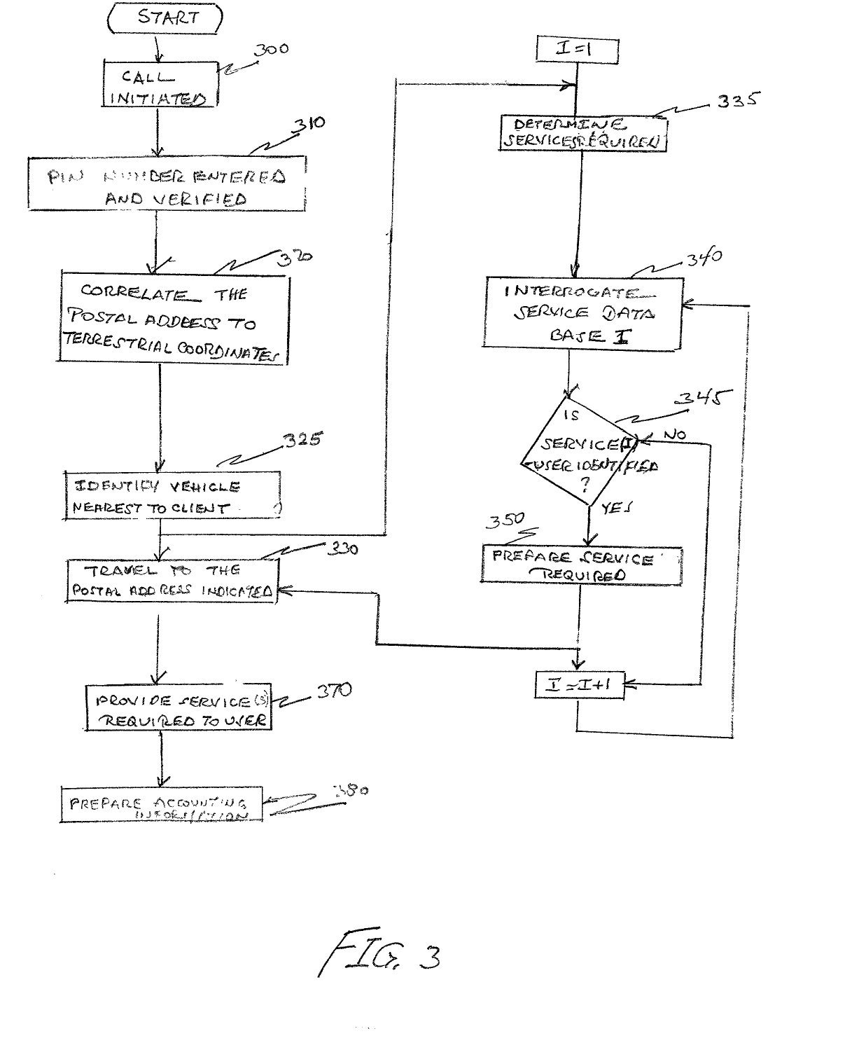

Referring now to FIG. 3, there is shown an example of a flow chart illustrating the process steps performed in accordance with the present invention.

By way of example, if a ‘meal on wheels’ (i.e., meals delivered to homebound clients) is to be delivered to various clients living at locations that are unknown to the service supplier of the vehicle, under normal circumstances, the supplier loses a significant amount of time trying to determine the exact address. Even if there were ways of finding the exact location, under the present state of the art, such a service would not be efficiently provided. Therefore, it will be of great advantage if the supplier of the service would have available at the earliest possible time an exact description of the service to be provided. For instance, in the present example, if the supplier has in his vehicle a choice of various menus reflecting the particular needs and taste of each client, the meal could be put together ‘in real-time’, thereby introducing significant savings of time, effort and money.

Still referring to FIG. 3, at step 300, a call is initiated by a client requesting a specific service. As previously mentioned, and for illustrative purposes only, it is once again assumed that the caller, who is home bound, desires that a ‘meal on wheels’ be delivered. The caller is further assumed to be physically incapacitated and living alone in the house. The system prompts the caller to enter his/her pin number (step 310), which is verified in real time. After completion of the verification process, the system requests the caller to hang up.

In a particular embodiment, the system retrieves the telephone request and identifies the pin number. The system correlates the pin number to the client who initiated the telephone call and retrieves (from the data base (260) in FIG. 2) the current address of the client. The system further correlates the terrestrial coordinates applicable to the postal address of interest, pinpointing the precise position by a set of terrestrial coordinates (i.e., the geographical position) (step 320) which are preferably stored in the data base (DB 260 of FIG. 2) and which were originally provided by the position locator, e.g. GPS, LORAN and the like. The geographical position of a delivery vehicle nearest to the client's terrestrial coordinates is then determined (step 325). Knowing where the nearest service supplier's vehicle is located with respect to the coordinates of the client, make it possible for the service supplier to be guided to the exact address of the client. Details of a navigation process based on two sets of geographic positions are described in U.K. Patent No. 2,322,445, herein incorporated by reference in entirety for all purposes. In further embodiments, the present invention includes a display with one or more directed vectors from a vehicles present position to the client's terrestrial coordinates.

Once the address (or pin number) has been added to the routing of the delivery circuit, a search in a second data base (DB 270 in FIG. 2) indicates the nature of the appropriate service (i.e., menu) (step 335). The system interrogates the second DB and learns the details regarding the service to be delivered (Step 340). By way of example, the information stored indicates that the client at that address is diabetic and suffers of other ailments requiring a sugar/salt free menu. Further information stored in the DB shows a preferred menu for each day of the week. Thus, the supplier may easily anticipate all the particulars applicable to the client and prepare for the delivery of the service beforehand (step 350). The system may be expanded by allowing the supplier to interrogate the system to determine whether other related services must also be delivered Examples may include, notifying the monitor at the central location of the supplier's whereabout, or informing a third party that the services has been delivered and perhaps receive additional instructions concerning the client, providing another type of service, etc.

At step 370, the service supplier delivers the service to the client being guided to its destination by the navigational system. The service supplier is now ready to respond to the next caller's telephone call. If none is forthcoming, the supplier returns to base (step 380). When the number of callers accumulate at a rapid pace, the system may optimize the route to be followed in accordance to the geographical coordinates being provided by the system, the availability of required services on board, the relative position of other vehicles that are available, etc.

Alternatively, in a second advantageous embodiment, a list of services to be delivered at a given location may preexist but the system can be adapted to allow new addresses to be added to the itinerary in response to new telephone calls being made since the supplier leaves the central office or point of departure. (Note: this provision is necessary particularly in instances when many telephone calls are made in a relatively short period of time). Again, the order of the various stops can be optimized at any time to allow better efficiency in the delivery of the service. The system can be modified by having all the calls arriving at a central location and distributed among the various vehicles in service as a function of their geographical position at any given time.

In yet another embodiment, the telephone calls may arrive at the central location which classifies the incoming calls in accordance with the particular service to be delivered, allowing different lists to be made and distributed among various service suppliers (drivers) as a function of the specific service requirements to be provided. However, even in such instances, added incoming calls may be responded by allowing added calls to be inserted to any given list.

### EXAMPLE 2

In a second example illustrative of another aspect of the invention, a call is initiated to report a fire, a burglary, a medical emergency, and the like. Let it be assumed for illustrative purposes that the caller reports a medical emergency and reports the nature of the particular emergency. Let it be further assumed that the call takes place at night.

As previously stated, an emergency call in the middle of the night presents certain difficulties since a postal address may be difficult to find particularly when the number of the postal address is not clearly visible or legible. Thus, finding the exact location may lead to severe loss of time, which under emergency conditions may prove dangerous or fatal.

Other difficulties relate to the nature of the medical emergency. Paramedics may not have on hand the full history of the ailing person and thus may not be prepared to treat the patient as required.

The system in accordance with the present invention requires clients to provide a complete medical history. Thus, when a call is initiated, the caller may just identify the ailing person by name, code number, or by any other identifier.

Referring again to FIG. 3, the pin code in this instance is, preferably replaced by a member ID. By interrogating a first DB, the postal address is retrieved and the terrestrial coordinates are extracted from the library. A geographical navigator (GPS, LORAN, . . . ) provides driving instructions to the service supplier allowing the emergency vehicle to stop at the exact location of the caller within a small margin of error.

While the emergency vehicle is traveling towards the address obtained from the first DB, medical personnel on board of the vehicle interrogate the system to retrieve from a second DB: 1) the prior history of the patient and 2) the necessary equipment and/or medical supplies to be put in action the moment the vehicle arrives at its destination. The availability of this information and the possibility of preparing for this emergency provides the chance of treating the ailing individual in a most effective manner.

The person in distress may input a different key for each class of distress, (e.g., fire, robbery, medical emergency) which prompts an electrical (or acoustic) signal at a different frequency to be emitted and to be received by appropriate emergency personnel, (e.g., police, fire department, medical assistance vehicle, etc.). In this manner, not only the location of the caller is determined instantly and with accuracy but the right kind of help will be summoned without having the person in distress having to say anything further. The different frequency may be activated by the caller as a particular code being entered.

The principles described can be applied to a variety of situations having a common denominator. By way of example, the delivery of parcels, mail, books, and the like could be greatly speeded but having the aforementioned items loaded in the vehicle, each coded by its own ID, and allowing the system guide the supplier to the exact location obtained by cross-correlating the terrestrial, coordinates to the postal address and allowing the service supplier pick up the item assigned to the given location without having to search for the address or the item to be delivered.

Thus, in an example embodiment of the present invention, the post office or other service provider provides special services according to the type of handicap of the recipient at the postal address. This type of information resides, preferably, in a client's registry. By way of example, the special service reads mail or other information to a blind person or places the mail directly in the office/kitchen of an immobilized person, or medication can be delivered to the bed of a sick person, in accordance with appropriate authorizations and requests by the handicapped person.

Other applications include having, e.g., a pharmacy provide rapid and/or timely delivery of medication to clients based on a list a renewal dates stored in the DB. The client or the supplier may initiate a call to confirm the order, and the delivery may be on its way as soon as confirmed by the client, supplier, client surrogate, and/or physician.

In an alternative embodiment, the postal service also performs services to individuals, companies etc., which are in no way handicapped, for instance, by ascertaining that the package is delivered to the addressee at the location obtained from the position locator. This may also trigger an acknowledgment of actual or correct delivery.

The system is further equipped to deliver a service to a postal address without resorting to the geographical positioning or vice versa, by using only the terrestrial coordinates without the postal address. Since it is the most effective delivery of the service, including preparing for the delivery of the service at the earliest possible time, the best way of retrieving the address of the client may be under certain circumstances of secondary importance.

Thus, the present invention provides business methods for a business to provide a service based on correlating a postal address of a service requester with the geographic location of the postal address. It enables a service supplier to use this correlation to satisfy each service request even when the postal address, or direction to the postal address, is not recognized by the service supplier.

In a particular embodiment, the service supplier obtains direction and travel information from the geographic location the service supplier happens to be at that particular instance, to the correlated geographic location of the service requester.

Besides supplying service to individuals, the invention provides the business to rapidly supply and satisfy a company of any special requests. Examples include performing pickup and/or delivery functions for the company; addressing and mailing company products stored in the vehicle or at one or more centrally located warehouse sites; copying and/or binding parts for entire publications available to the vehicle/vehicle operator; purchasing and delivering items and/or supplies as supplies are needed and/or are used up, and/or any similar quick response function.

In a further example embodiment, the invention provides a business method including the steps of: a business providing a plurality of services to a plurality of clients; cross-referencing a postal address of each client from said plurality of clients to a geographical location corresponding to said postal address; obtaining information relative to an individualized service to be provided to at least one client from said plurality of clients; and providing said individualized service to said at least one of said clients based on said geographical location and said information.

In yet another embodiment, the method includes the step of cross-referencing includes using a first database having the postal address and the geographic location for each of the clients, and using a second data base having information relative to the individualized service to be delivered to each of the plurality of clients; wherein the second database includes information selected from the group that includes: type of addressee, service requirements, special attention, client type, mode of payment, previous postal addresses, terrestrial coordinates of previous postal address, forwarding postal address, forwarding terrestrial location, approved surrogates, client company policies, financial tabulations, client account data and preferences, client reporting requirements and any combination of these; and/or the client is a company, individual, small business, a home business, and/or the service is a service taken from a group of services including: providing quick purchasing, providing pickups, providing deliveries, performing automated addressing and mailing services, providing pickup and delivery of employee and/or customers from a first location to a second location, and any combination of these. Thus the invention provides, e.g., a service for supplying small businesses with supplies and services, even when the small business is at a remote location.

In still another example embodiment, the invention provides a business method that includes: having a business' supplier provide a plurality of services to a plurality of service providers. The business' supplier trains each of the service providers: in employing a cross-referencing of a postal address of each client of the each of the service providing businesses to a geographical location corresponding to the postal address; in obtaining information relative to an individualized service to be provided to the each client; and in providing the individualized service to the at least one of the each client based on the geographical location and the information. In a particular embodiment, the business method further comprises the steps of: having the business' supplier monitor, control, and direct at least one of the plurality of service providers businesses.

While the invention is described generally as a method for doing business, the methods and apparatus are useful in their own stead for providing their resulting advantages in other applications and utilization.

Furthermore, while the invention is described generally as a method for doing business, the methods and apparatus are useful for use for a general business controlling, monitoring, setting up, training, and/or satisfying the requirements of a plurality of special service business.

The present invention may be realized in hardware or software or a combination thereof. Further, it may be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after conversion to another language, code or notation and/or reproduction in a different material form.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

Thus while the present invention has been shown and described with respect of specific embodiments, it will be understood that it is not thus limited. Numerous modifications, changes and improvements will occur which fall within the scope and the spirit of the invention.

What is claimed is:

1. A method for providing a service, comprising the steps of:
cross-referencing a postal address of each client from a plurality of clients to a geographic location for each of said clients;
obtaining information relative to an individualized service to be provided to at least one of said plurality of clients; and
providing said individualized service to said at least one of said clients based on said cross-referencing and said information.

2. The method as recited in claim 1, wherein the step of cross-referencing includes using a first database having said postal address and said geographic location for each of said clients, and using a second data base having said information relative to said individualized service to be delivered to each of said plurality of clients.

3. The method as recited in claim 2, wherein said second database includes information selected from the group that includes: type of addressee, service requirements, special attention, type of occupant, mode of payment, previous postal addresses, previous terrestrial coordinates locations, forwarding postal address, forwarding terrestrial location, approved surrogates, company policies, reporting requirements and any combination of these.

4. The method as recited in claim 1, wherein said postal address and said geographic location for each of said clients and said information relative to said individualized service to be delivered to each of said plurality of clients are stored in a common data base.

5. The method as in claim 1, further comprising the step of ascertaining the status of the delivery of said service.

6. The method as in claim 1, further comprising the step of notifying said at least one client when said individualized service is completed.

7. The method as in claim 1, further comprising notifying said at least one client of a planned delivery of said service.

8. A method for responding to a distress call initiated by an individual at an unrecognized postal location, the method comprising the steps of:
responsive to the distress call, having a monitoring station correlate from a first data base a geographic position address corresponding to the unrecognized postal address;
determining from the correlated address selected information stored in a second data base pertinent to the individual in distress;
transmitting to an emergency vehicle the selected information and the correlated geographic position address corresponding to the postal address; and
having the emergency vehicle deliver the service based on the correlated address and the selected information.

9. The method as in claim 8, wherein said information includes determining a prior medical history of the person in distress from the second data base, and responsive to the medical history providing an optimum response applicable to the person in distress.

10. A method comprising:
delivering a service to a handicapped person at a postal address, the method including the steps of:
creating a first database for cross-referencing said postal address to terrestrial coordinates for each handicapped person of a plurality of handicapped persons;
creating a second database for storing details pertaining said service applicable to said handicapped person to be delivered at said postal address; and
providing said service to said handicapped person based on said cross-referenced location and on said selected information retrieved from said second database.

11. The method as in claim 10, wherein said service includes providing a rapid and timely delivery of medication to said handicapped person based on a list a renewal dates stored in said second data base.

12. The method as in claim 11, wherein said handicapped person initiates a call to confirm an order, that delivery is on its way as soon as confirmed by said handicapped person.

13. The method as in claim 10, wherein said service is selected from the group that includes: verifying whether said postal service is delivered at a correct location; determining a preferred delivery mode required by said handicapped person; notifying a sender of completion of said delivery; providing a specialized service according to the type of handicap of said handicapped person living at said postal address; forming a postal handicapped client registry; delivering said postal service at a location directed to an immobile person; delivering of medication to the bed of a sick person and any combination thereof.

14. A system for providing a service to an addressee at a postal address comprising:
a first database for cross-referencing said postal address to terrestrial coordinates for each addressee forming a cross-referenced location of a plurality of addressees;
a second database for storing selected information relative to said plurality of addressees; and
means for providing said service to at least one of said addressees based on said cross-referenced location and said selected information retrieved from said second database.

15. The system as recited in claim 13, wherein said second database includes information selected from the group that includes: special needs of the addressee, postal service requirements, mode of payment, previous postal addresses, previous terrestrial position locations, forwarding postal address, forwarding terrestrial position location, and any combination thereof.

16. The system as in claim 14, further comprising means for ascertaining the status of the delivery of said service.

17. The system as in claim 14, further comprising means for notifying said at least one addressee or surrogate of said addressee of the completion of a particular delivery of said service.

18. The system as in claim 14, further comprising means for notifying said at least one addressee or surrogate of said addressee of a planned delivery of said service.

19. A system for responding to a service request call initiated by a service requester at an unrecognized postal location, the system comprising:
a monitoring station for responding to the service call and for correlating from a first data base a geographic position address corresponding to the unrecognized postal address forming a correlated geographic position address;
means for cross-referencing with said correlated address selected information stored in a second data base pertinent to said service requester;
means for transmitting to a service supplier said selected information and said correlated geographic position address corresponding to said postal address; and
delivery means for said service supplier to deliver said requested service based on said correlated address and said selected information.

20. The system as in claim 19, wherein said service requester is a person in distress, and said special information includes a prior medical history of said person in distress taken from said second data base and, wherein said delivery means uses the medical history in providing an optimum response applicable to said person in distress.

21. The system of claim 19, wherein said service requester is a business and said service request is for copies of a publication included in said delivery means.

22. A system for delivering at least one postal service to at least one service requester from a plurality of service requesters, each service requester being at a known postal address, the system comprising:
a cross-referencing module for cross-referencing said known postal address to terrestrial coordinates, forming a cross-referenced location for said at least one service requester;
a second database for storing information pertaining said at least one postal service applicable to each of said plurality of service requesters to be delivered at said known postal address; and
a service provider module for providing said service based on said selected information retrieved from said second database at said cross-referenced location.

23. A system as in claim 22, wherein said at least one service requester is a handicapped person.

24. The system as in claim 23 wherein said handicapped person is blind or immobilized.

25. The system as in claim 22, wherein said postal service is selected from the group of services that includes: verification that the postal service is delivered at the correct location; a preferred delivery mode required by a handicapped person; notification to a sender of completion of said delivery; delivery of a specialized postal services according to a type of handicap of a handicapped person living at said postal address; formation of a postal client registry; delivery of said postal service at a location directed to a client companies service needs; delivery of medication to the bed of a sick person, and any combination thereof.

26. An article of manufacture comprising a computer usable medium having computer readable code means embodied therein for causing delivery of a service, the computer readable program code means in said article of manufacture further comprising computer readable program code means for causing a computer to effect the steps of:
cross-referencing a postal address of each client from a plurality of clients to a geographical location for said each client;
obtaining information relative to an individualized service to be provided to at least one of said plurality of clients; and
providing said individualized service to said at least one client based on said cross-referencing and said information.

27. A computer program product comprising a computer usable medium having computer readable program code means embodied therein for causing a delivery of a service, the computer readable program code means in said computer program product comprising computer readable program code means for causing a computer to effect:
cross-referencing a postal address of each client from a plurality of clients to a geographic location for each of said clients;
obtaining information relative to an individualized service to be provided to at least one of said plurality of clients; and
providing said individualized service to said at least one client based on said cross-referencing and said information.

28. A business method comprising the steps of:
having a business provide a plurality of services to a plurality of clients;
cross-referencing a postal address of each client from said plurality of clients to a geographical location corresponding to said postal address;
obtaining information relative to an individualized service to be provided to at least one client from said plurality of clients; and
providing said individualized service to said at least one client based on said geographical location and said information.

29. The method as recited in claim 28, wherein the step of cross-referencing includes using a first database having said postal address and said geographic location for each of said clients, and the step of obtaining includes using a second data base having said information relative to said individualized service to be delivered to each of said plurality of clients.

30. The method as recited in claim 29, wherein said second database includes information selected from the group that includes: type of addressee, service requirements, special attention, client type, mode of payment, previous postal addresses, terrestrial coordinates of previous postal address, forwarding postal address, forwarding terrestrial location, approved surrogates, client company policies, financial tabulations, client account data and preferences, client reporting requirements and any combination of these.

31. The method as recited in claim 28, wherein said client is a business and said service is selected from the group of services including: providing quick purchasing, providing pickups and deliveries, performing automated addressing and mailing services, providing pickup and delivery of employees or customers from a first location to a second location and any combination thereof.

32. A business method comprising the steps of:
having a business' supplier provide a plurality of services to a plurality of service providing businesses;
having said business' supplier train each of said service providing businesses in:
employing a cross-referencing of a postal address for each client of each of said service providing businesses at a geographic location corresponding to said postal address;
obtaining information relative to an individualized service to be provided to each of said clients; and
providing said individualized service to each of said clients based on said geographical location and said information.

33. A business method as in claim 32, further comprising the steps of having said businesses supplier monitor, control or direct at least one of said plurality of service providing businesses.

34. An article of manufacture comprising a computer usable medium having computer readable code means embodied therein for causing delivery of a service, the computer readable program code means in said article of manufacture further comprising computer readable program code means for causing a computer to effect the steps of claim 28.

35. An article of manufacture comprising a computer usable medium having computer readable code means embodied therein for causing delivery of a service, the computer readable program code means in said article of manufacture further comprising computer readable program code means for causing a computer to effect the steps of claim 32.
